(19) United States
(12) Patent Application Publication
(10) Pub. No.: US 2008/0082348 A1
(43) Pub. Date: Apr. 3, 2008

(54) Enterprise Integrity Content Generation and Utilization

(76) Inventors: Sachar M. Paulus, Weinheim (DE); Guido Wagner, Ludwigshafen-Hochheim (DE); Gunter Bitz, Bruehl (DE)

Correspondence Address: FISH & RICHARDSON, P.C., PO BOX 1022, MINNEAPOLIS, MN, 55440-1022, US

(21) Appl. No.: 11/538,038

(22) Filed: Oct. 2, 2006

(51) Int. Cl. G06Q 10/00; G06Q 30/00

(52) U.S. Cl. 705/1

(57) ABSTRACT

Methods and apparatus, including computer program products, for risk assessment and analysis. In one general aspect, asset data representing a set of assets is received. Threat data representing a set of threats is received. Requirements data representing one or more requirements is received, wherein each requirement requires compliance with a regulation and a failure to satisfy the requirement constitutes a threat additional to the set of threats. Measures data representing a set of measures is received. A current status is calculated using the measures data and the requirements data based on a level of compliance with the requirements, the level of compliance determined by the measures and the additional one or more threats to one or more assets represented by the measures data and the requirements data.

### BACKGROUND

The present invention relates to a knowledge processing system for risk assessment and analysis.

Risk management is an important consideration for any organization. However, potential risks fall into a very diverse array of categories, including risks relating to information technology (e.g., computer viruses or hackers), risks relating to physical facilities (e.g., fire, flood, earthquake, or burglary), as well as legal risks (e.g., failure to comply with statutory or regulatory requirements). In addition, measures that can be taken to mitigate potential risk can frequently overlap and protect against multiple risks, even across different categories. For example, a security system added to protect a file or web server from physical attacks can protect against hackers gaining physical access to the server, mitigating an information technology risk, as well as protect against burglaries, mitigating a physical facilities risk.

However, different individuals and divisions within an organization are typically responsible for the different risks that the organization faces. For example, the legal division of an organization might be concerned with regulatory risks, while the information technology department is concerned with information technology risks. Ordinarily, information is not readily shared between these divisions, making it difficult to manage the total risk of an organization, as well as determine the most effective projects that can be undertaken to reduce risk across the entire organization.

### SUMMARY OF THE INVENTION

In general, in one aspect, embodiments of the invention feature receiving asset data representing a set of assets, the asset data including a respective value for each asset in the set of assets having a value. Threat data representing a set of threats is received; each threat in the set of threats potentially reduces the value of one or more of the assets in the set of assets. Requirements data representing one or more requirements is received, wherein each requirement requires compliance with a regulation and a failure to satisfy the requirement constitutes a threat additional to the set of threats. Measures data representing a set of measures is received; each measure in the set of measures protects the value of one or more assets from the additional one or more threats of failing to satisfy the one or more requirements. A current status is calculated using the measures data and the requirements data based on a level of compliance with the requirements, the level of compliance determined by the measures and the additional one or more threats to one or more assets represented by the measures data and the requirements data.

The invention can be implemented to include one or more of the following advantageous features. Project data representing a proposed project may be received, the proposed project modifying the set of measures by adding additional measures to the set of measures or enhancing one or more measures in the set of measures or both. A return on investment of the proposed project may be calculated based on the modified set of measures and the additional threat. The current status may be represented by a percentage value, with 100 percent representing full compliance with the one or more requirements and 0 percent indicating no compliance with the one or more requirements. The current status may be displayed graphically, wherein the current status is indicated by one of the following colors: red, indicating no compliance or a low level of compliance; yellow, indicating a medium level of compliance; and green, indicating a high level of compliance or full compliance. A report may be generated, the report indicating the level of compliance with the one or more requirements.

In another aspect, asset data representing a set of assets is received, the asset data includes a respective value for each asset in the set of assets having a value. Threat data representing a set of threats is received; each threat in the set of threats potentially reduces the value of one or more of the assets in the set of assets. Measures data representing a set of measures is received; each measure in the set of measures protects the value of one or more assets from one or more threats. Assessment data representing one or more assessments is received; each assessment rates one or more measures. An implementation level for each measure is calculated based upon the assessment data.

The invention can be implemented to include one or more of the following advantageous features. A potential reduction of risk of one or more assets may be calculated due to the implementation level of each measure. A report may be generated, the report including one or more of the status of each asset or group of assets, the status of each threat or group of threats, the status of each measure or group of measures, or the implementation level for each measure or group of measures, and the report may be displayed to one or more individuals. Each assessment may include three ratings: knowledge, readiness, and penetration. The assessment may be received from e an interview form, the interview form including one or more questions about each measure. The interview form may be completed by an individual with knowledge of one or more measures. The interview form presented to the individual may only includes questions relating to the one or more measures knowledgeable to the individual. The individual may respond to the questions included on the interview form by selecting a color code representing the individual's response. The color code may include the following colors, each color being associated with a numerical rating: red, indicating a low rating of the measure by the individual; yellow, indicating a medium rating of the measure by the individual; green, indicating a high rating of the measure by the individual, white, indicating that the rating of the measure is unknown by the individual, and black, indicating that the measure is not applicable to the individual.

In another aspect, asset data representing a set of assets is received, the asset data includes a respective value for each asset in the set of assets having a value. Threat data representing a set of threats is received; each threat in the set of threats potentially reduces the value of one or more of the assets in the set of assets. Measures data representing a set of measures is received; each measure in the set of measures protects the value of one or more assets from the additional one or more threats of failing to satisfy the one or more requirements. A loss expectancy based upon the value of the assets, the potential reduction of value caused by the threats, and the protection of the value caused by the measures is automatically calculated. Project data representing a simulated project is received, the simulated project modifying one or more assets, threats, or measures. A revised loss expectancy is automatically calculated based upon the value of the assets, the potential reduction of value caused by the threats, and the protection of the value caused by the measures as modified by the simulated project. A savings caused by the simulated project is automatically calculated based upon the loss expectancy and revised loss expectancy.

The invention can be implemented to include one or more of the following advantageous features. A cost of the simulated project may be received. A return on investment based on the savings and the cost may be calculated. A report may be generated, the report including the savings caused by one or more simulated projects and/or the return on investment of one or more simulated projects.

The invention can be implemented to realize one or more of the following advantages. Data relating to security risks and concerns and considerations can be gathered and integrated from a wide array of sources. The individual or individuals responsible for a particular area are automatically informed of risks and concerns that fall within their responsibilities. The workload on any single person to report on security measures is reduced. Reports can be generated that reflect the security and risk situation of an entire organization, including the individual units that make up the organization, in addition to reports generated for each individual unit. Reports can be generated on a real-time basis, reflecting the most current information available. Predictions and recommendations can be automatically provided based on the information available. The risks and benefits of a potential project can be simulated, and the return on investment for the potential project can be calculated. Potential changes in the physical or regulatory environment can be simulated to determine possible risks, as well as to determine potential measures that can be taken to ameliorate my additional risk. One implementation of the invention provides all of the above advantages.

Details of one or more implementations of the invention are set forth in the accompanying drawings and in the description below. Further features, aspects, and advantages of the invention will become apparent from the description, the drawings, and the claims.

### BRIEF DESCRIPTION OF THE DRAWINGS

FIG. 1 is a block diagram of a security-related infrastructure.

FIG. 2 is a block diagram of an information gathering and reporting system.

FIGS. 3A and 3B are illustrations of forms used to collect information from a user.

FIG. 4 illustrates the consolidation of statuses for a single measure.

FIG. 5 illustrates the consolidation of statuses for a single asset.

FIG. 6 is a block diagram of a system for combining and distributing information relating to the risk status of an organization.

FIGS. 7 and 8 illustrate computer-generated displays of information relating to the implementation of security measures.

FIGS. 9-13 illustrate computer-generated displays of information providing details of an organization's status to a computer user.

FIG. 14 illustrates a form used to simulate a proposed project.

FIG. 15 illustrates a layer structure for a set of assets.

FIG. 16 illustrates a hybrid goal-based and trigger-based approach to identifying threats to an enterprise.

FIG. 17 is a threat tree used for identifying threats to an enterprise.

FIG. 18 is a table diagram for an asset-threat-measure database.

FIG. 19 illustrates data objects which may be used for a ROSI (return on security investment) calculation model.

Like reference numbers and designations in the various drawings indicate like elements.

### DETAILED DESCRIPTION

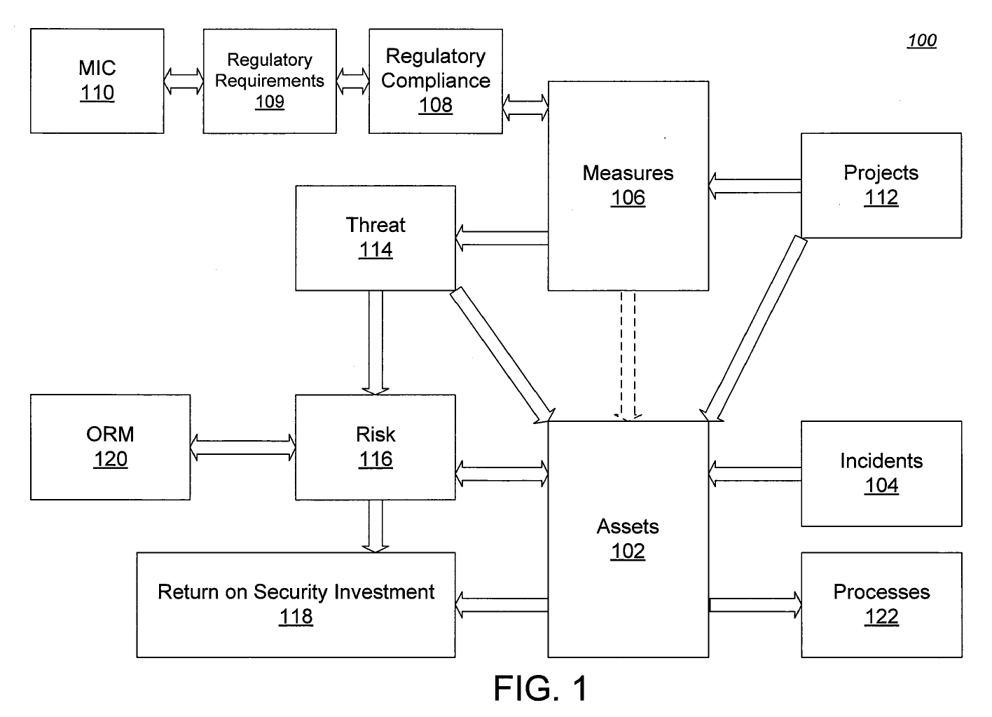

FIG. 1 illustrates a security-related infrastructure for an organization. The organization has assets 102. Anything that has value to the organization and that requires protection can be an asset. Assets can include tangible and non-tangible items. Examples of possible assets 102 include customer data, a Windows server, facilities/physical plant, employees, brand value, and public image. Typically, it is desirable to keep the value of a particular asset as high as possible; alternatively, it is also desirable to keep the total cost of ownership (“TCO”) for a particular asset as low as possible. The assets 102 are used by the organization to support the various processes 122 undertaken by the organization in its ordinary course of business.

Security related incidents 104 generally lower the value of one or more assets 102. A single incident can lower the value of a single asset or the value of multiple assets at the same time. For example, a fire at a warehouse lowers the value of the physical plant, lowers the value of any inventory damaged by the fire, and can even lower the value of employees staffed at the damaged warehouse if the organization is unable to find useful work for these employees. A different kind of incident is a flaw discovered in a product produced by the organization; the product flaw can potentially lower shareholder value as well as the public reputation of the organization. Although many incidents are not scheduled, and happen without warning, incidents can also be anticipated in advance.

In order to protect the value of assets 102, measures 106 can be implemented to protect the value of the assets 102. Examples of measures 106 include virus protections, building access controls, emergency and crisis management plans, business continuity and impact analysis, and segregation of duties. Measures can be implemented for a variety of reasons. Contractual obligations between the organization and third parties might call for particular measures. Various security standards, such as the ISO 27001 security standard and the CoBIT security standard specify measures that may have to be implemented. The organization's own policies can dictate other measures. The processes 122 can include the implementation of measures 106.

In addition, regulations 108 set forth various regulatory requirements 109 that impact the measures 106 taken by the organization. For example, the Sarbanes-Oxley Act of 2002 (SOX) of the United States sets forth legal requirements that potentially require that one or more measures 104 be undertaken by the organization in order to comply with the SOX rules and regulations. Similarly, the KonTraG laws of Germany set forth legal requirements that might require other measures in order to comply with the KonTraG regulations. The organization's internal controls 110 help to ensure that measures 106 are implemented to allow the organization to comply with the various regulations 108.

Projects 112 undertaken by the organization can affect the quality and effectiveness of measures 106, as well as affect assets 102. Projects 112 can include business projects undertaken by the organization; these business projects may not be intended to affect the measures 106, but can often have either a positive or a negative impact on at least one, and typically more than one, measure 106. For example, a business project designed to expand operations to a new country might require additional measures to be put into place in order to comply with local laws. However, this same business project can also have a negative impact on other measures, e.g., if the organization leases a new building that does not have the same level of building access controls as the rest of the organization's facilities. In addition, projects can influence assets; for example, an asset might be shifted to a different location, or the total cost to own an asset increases because of the particular project.

Projects 112 can also include security projects that are specifically designed to have a positive impact on one or more measures 106. For example, a security project to install a fire sprinkler system adds an additional measure to the measures 106 that protect the organization's assets 102—in this case, the sprinkler system helps protect the physical plant from the threat of fire.

Threats 114 include any potential incidents that would harm one or more assets 102. As will be described later, each threat can be associated with a single loss expectancy (SLE) factor; the SLE factor is based on both the likelihood of the particular threat, as well as the financial impact of the threat on the assets 102. For example, the likelihood that an employee will fall ill is quite high, but the financial impact of having an employee stay home for a day or two is quite small. On the other hand, the likelihood of an earthquake is very low, but the is financial impact of the earthquake would be quite high. In addition, the likelihood of a particular threat can be affected by the geographical location of the assets 102 to which the threat relates. For example, an earthquake in Japan is more likely than an earthquake in Germany.

The likelihood and financial impact of the threats 114 allow a risk 116 to be calculated. The risk 116 is expressed as a currency value, e.g., dollars, euros, yen, etc., and is the mathematically expected cost to the organization of all the threats 114 on the assets 102, based upon the value of the assets 102 and the likelihood of the threats 114 on the assets 102 over a particular time window. In addition, based on the cost of the projects 112 or measures 106 or both, as well as the change of risk 116 that occurs based upon the projects 112 or measures 106, the return on investment of a particular security investment 118 can be calculated. The return on security investment 118 is the ratio of the difference between the original risk without the security investment and the revised risk after the security investment is included, divided by the cost of the security investment, multiplied by 100 to express the return as a percentage. The risk 116 can also be used by an operational risk management (ORM) 120 program to determine the impact of particular threats as well as measures against one or more threats.

The following is an example of the relationship between measures, threats, and assets. An organization monitors computer system access and use; this is a measure taken by the organization. This measure helps mitigate the threats of hacking attacks as well as industrial espionage. Another measure implemented by the organization is building access control. The building access control helps to reduce the threat of industrial espionage as well as burglary. Finally, the organization also implements emergency and crisis management plans. Such plans can mitigate the threats of hacking attacks, industrial espionage, burglary, and natural disasters.

Further, each of these threats has a potential impact on one or more of the organization's assets. For example, a hacking attack could impact a computer server, or result in a breach of the organization's confidential data. Industrial espionage could also have an impact on the computer server or the organization's confidential data. The burglary is might have an impact on the computer server, as well as on the server room itself. Finally, a natural disaster might have an impact on the computer server, the server room, and the employees of the organization.

Some measures might be required by various government and industry regulations. For example, both KonTrag and SOX include a requirement that critical organizational data be backed up. The German Data Protection Act (Deutsches Datenschutzgesetz) requires that in addition to data backup, both physical access controls and availability controls be implemented within an organization to protect confidential data.

Further, the measures and assets can all be affected by projects undertaken by the organization. For example, the opening of a new data center, the outsourcing of information technology (IT) services, and identity management all represent projects that could impact the organization's assets, requiring the adjustments of the organization's measures.

In addition, external changes can impact the organization's measures and the threats to the organization's assets. For example, a new threatening technology introduced by a competitor might represent a new threat, to which the organization must adapt. Other external changes might include various political events, such as the introduction of proposed legislation or a change in power after a government election. Physical changes to the environment can also have an impact on the organization; for example, if a new nuclear power plant is constructed near the organization's facilities, the organization may need to adapt its measures in order to deal with the threat that this new power plant might pose.

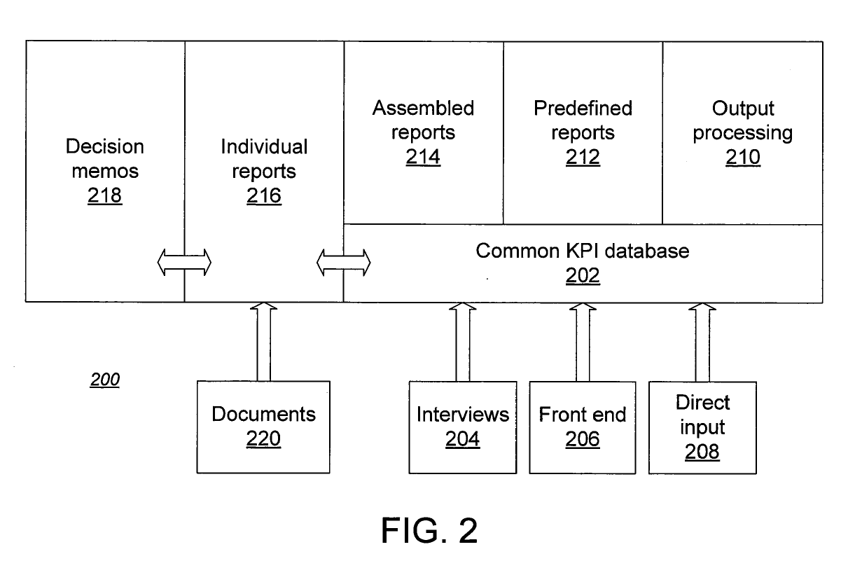

FIG. 2 illustrates an information gathering and reporting system 200 that can monitor various measures that have been or may be implemented by the organization, gather information about these various measures, and generate reports concerning the condition of the organization's security system based upon the status of these measures. The reporting system 200 includes a common key performance indicator (KPI) database 202. In one implementation, the three KPI measurements are readiness, penetration, and knowledge.

Knowledge refers to the knowledge required to implement a particular measure. The level of knowledge can be associated with one of three levels. At a lowest level, the organization does not have the expertise required to implement the measure, or there is a major lack of expertise within the organization. At a middle level, expertise is building up within the organization, but it is not yet at a level required to fully implement the measure. At a highest level, there is expertise where needed throughout the organization, and the expertise is such that the measure could be fully implemented. The level of knowledge for a particular measure within the organization can also be unknown.

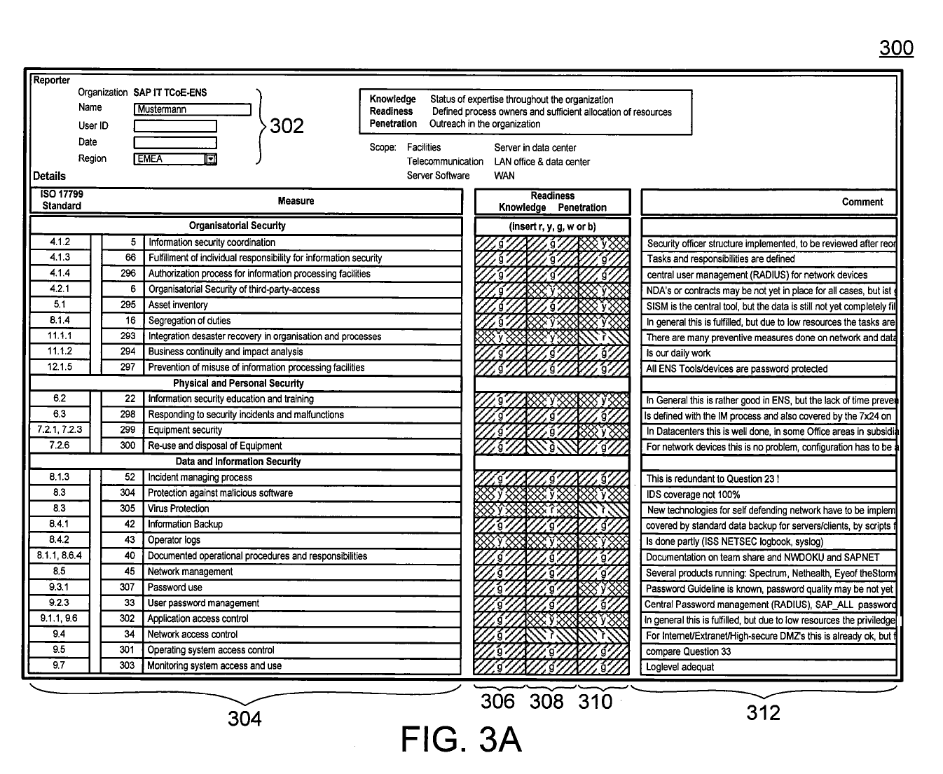

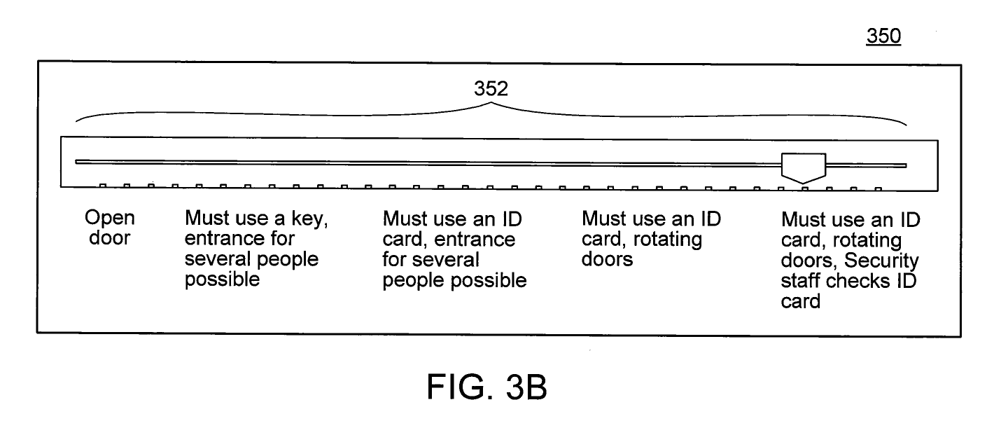

Readiness refers to the management of the implementation of a particular measure. At a lowest level, there is no defined process owner for the particular measure, or the process is not running at the present time. At a middle level, there is a defined process owner for the particular measure, and the process is being implemented, although the process is not running at its full potential because of insufficient resources or other constraints. At a highest level, there is a defined process owner for the particular measure, there are sufficient resources for the process, and the process is running at its full potential. Alternatively, the level of readiness for a particular measure within the organization can be unknown. An alternative implementation involving the use of an interview form is described below in reference to FIG. 3B.

Penetration refers to the implementation status of a particular measure. At a lowest level, the particular measure is not implemented, or implementation has not yet started. At a middle level, the particular measure is partially implemented; the measure has been communicated to the organization, and is being carried out. At a highest level, the particular measure is fully implemented; the measure is working and is being monitored for effectiveness. Alternatively, the level of penetration for a particular measure within the organization can be unknown.

In one implementation, KPI levels are represented visually by the colors red, yellow, and green; the lowest level of a particular KPI is associated with the color red, the middle level of a particular KPI is associated with the color yellow, and the highest level of a particular KPI is associated with the color green. This will be referred to as the “traffic light” measurement and reporting system.

Information about the various KPIs can be provided to the common KPI database 202 in a variety of ways. For example, interviews 204 can be presented to an individual for completion through a web-based interface or in any other alternative format, allowing individuals within the organization to provide information to the common KPI database 202. Further information about interview formats is provided below. A particular individual within the organization will not know everything about the organization, but is likely to know quite a bit about his or her area of specialization within the organization. By combining the information gathered from multiple interviews 204, the common KPI database 202 grows in comprehensiveness and accuracy. Information about the various KPIs can also be gathered through a front end 206 of the reporting system 200, or by a direct input 208 mechanism to the reporting system 200, e.g., input provided in the form of data files from other software applications. For example, individual incidents can be reported to the reporting system 200 by individuals using the front end 206, or by direct input from a separate incident reporting system.

In some implementations, each source of information can be assigned its own weighting. For example, an interview completed by the chief security officer can be given a larger weight as compared to an interview completed by a low-level employee such as a security guard, which would represent the assumption that the chief security officer is a more reliable source of information than a security guard.

Output processing 210 of the information gathered in the common KPI database 202 allows for the generation of both predefined reports 212 as well as assembled reports 214. Assembled reports 214 are custom reports reflecting specific information requested by one or more individuals. In addition, individual reports 216 can be generated for particular individuals based upon their needs and other documents 220. For example, a chief executive officer of the organization might want to have information about a first set of security issues; a chief security officer will likely want to have information about a broader set of security issues; and the board of directors will likely want a broad overview of the security of the organization. In addition, decision memos 218 can be prepared to provide specific information for particular individuals, and be limited in scope to include only information that is applicable in order for an individual to make an informed decision.

FIG. 3A shows an example of an interview form 300 that can be used to collect information about the KPIs from an individual. For example, this interview form can be web-based or can be completed on paper or as an electronic file for later input into the reporting system. Information 302 about the individual completing the interview form 300 can be collected. The interview form 300 can be customized for a particular individual, based upon the position of the individual within the organization. For example, a security guard can be asked questions about measures that protect physical assets, e.g., door locks, visitor registration procedures, etc., while a system administrator can be asked questions about measures that protect various computer systems and the data that these computer systems contain. Further, the interview form 300 can be further customized based upon the region where the individual is located; different measures might be in place for Europe than for North America.

The interview form 300 lists a variety of measures 304. Based upon the individual's knowledge of each of the measures, the individual can score each measure based on the three KPIs of knowledge 306, readiness 308, and penetration 310. In one implementation, the individual can score each measure based upon the three level traffic light color-coded system described above; all the individual needs to do for each KPI for each measure is select the appropriate color code that corresponds to the individual's assessment of each measure. If the individual has no knowledge about a particular measure (e.g., it is outside the scope of the individual's position), or the individual does not know the status of a particular measure, other color codes, such as white or black, can be used by the individual to indicate the lack of knowledge about a particular measure, or that the status of the particular measure is unknown. The individual also has the option of providing further written comments 312 regarding to the status of each measure that can be reviewed by other individuals within the organization.

In another implementation, an individual can be presented with a scale for each metric, allowing the individual to indicate the status of a particular measure on a sliding scale. FIG. 3B shows an example of an interview form 350 that can be used to collect information about the KPIs from an individual. Slider 352 can be adjusted by the individual to reflect the status of the measure. For example, at one extreme, no building access controls are installed, and anyone can enter or leave a building unrestricted. At the other extreme, each individual must use an ID card to operate a rotating door, as well as present the ID card to a security officer. Each individual can set the slider at the point which represents the actual status of the measure. As above, additional selections can be provided to the individual to indicate a lack of knowledge about a particular measure, or that the status of the particular measure is unknown.

The information gathered can be used to generate summaries relating to the status of individual measures, as well as the status of individual assets. In one implementation, the summary status can be reported using the traffic light system described above. Each of the KPIs measured, knowledge, readiness, and penetration, are combined into a single implementation level for each measure. The implementation levels of multiple measures within a single country can be combined to create an implementation level of all the measures in a single country; similarly, the implementation levels of multiple measures within a single division of an organization can be combined to create an implementation level of all the measures of a single division. The implementation levels of all the measures for multiple country or multiple division can be further combined to create an implementation level of all the measures for a region, a world wide status, or an entire organization, as desired. In each of these consolidation steps, the weighting of each individual implementation level for a measure is based on the value of the assets that are protected by the measure.

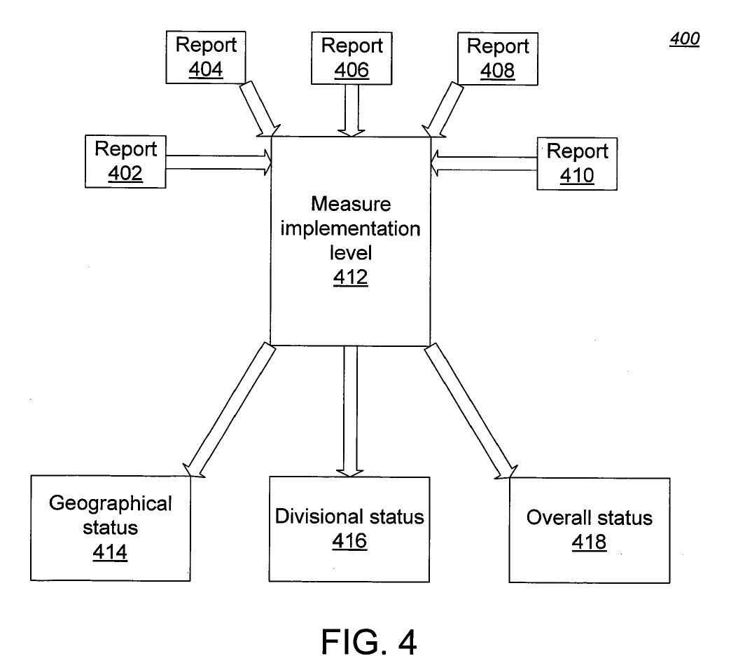

FIG. 4 illustrates the consolidation of traffic light status for a single measure. As described above, a variety of information submissions 402, 404, 406, 408, 410 are collected regarding a particular measure. These information submissions 402, 404, 406, 408, 410 are combined into a measure implementation level 412 that contains information from all of the data sources and information submissions 402, 404, 406, 408, 410. A geographical status 414 can be generated by applying a weighting algorithm to the measure implementation level 412. For example, if the status of a particular measure is desired for North America, any information in the measure implementation level 412 can be ignored unless it is associated with Canada, the United States, and Mexico. Further, if desired, different weighting factors can be applied to information associated with Canada, the United States, and Mexico; for example, based upon the organization's presence in each of these three countries. In one implementation, the geographical status 414 can be expressed using the traffic light system.

Similarly, a divisional status 416 can also be generated by applying a weighting algorithm to the measure implementation level 412. For example, if the status of a particular measure is desired for a human resources division, any information in the measure implementation level 412 can be ignored unless it is associated with the human resources division. Further, if desired, different weighting factors can be applied to information associated with the human resources division; for example, different weights can be applied to information that comes from payroll, benefits and the human resources IT department. In one implementation, the divisional status 416 can be expressed using the traffic light system: red applying to a divisional status below a certain threshold; green applying to a divisional status above a second threshold; and yellow applying to a divisional status falling between the two thresholds.

An overall status 418 can also be generated based upon the measure implementation level 412. The overall status 418 provides a summary status of the individual measure for the entire organization. In one implementation, the overall status 418 can be expressed using the traffic light system.

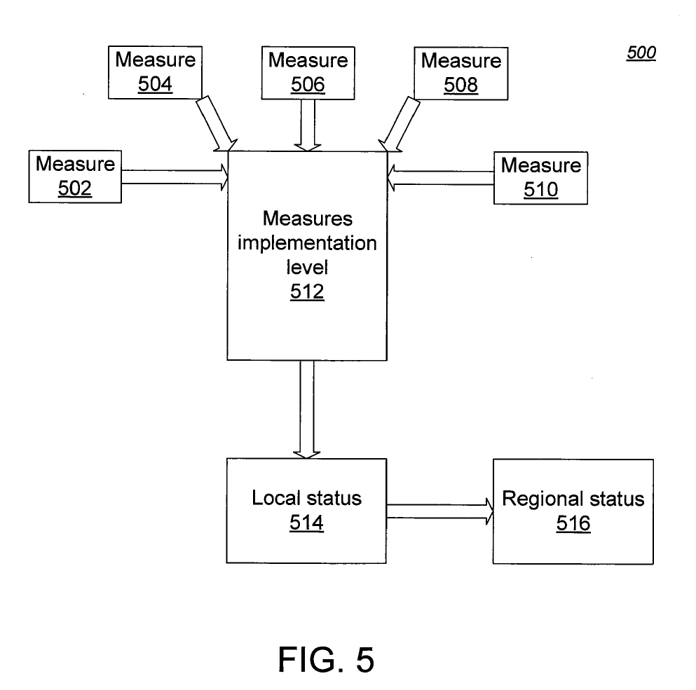

FIG. 5 illustrates the consolidation of traffic light status for a single asset. The status of each measure 502, 504, 506, 508, 510 relating to the asset is collected and combined into a measures implementation level 512 that contains information about all of the measures relating to the asset. A local status 514 can be generated by applying a weighting algorithm to the measures implementation level 512 in combination with the value of the protected asset. For example, if the status of a particular asset is desired, the measures implementation level 512 is combined with the value of the asset in order to determine the impact of the measures upon the asset. In one implementation, the local status 514 can be expressed using the traffic light system. Based upon the protection requirement of the asset in each of the countries within a region, a regional status 516 can be calculated. In one implementation, the regional status 516 can be expressed using the traffic light system.

The traffic light system is a user-friendly method of collecting and displaying data relating to the organization's security system; however, in order make use of data collected under the traffic light system, the data must be converted into numerical values. These numerical values can then be stored as status measures, K_{Type}, for each of the KPI types, namely, knowledge, readiness, and preparation. In addition, a weighting Kw_{Type} can be applied to each of these types of KPI, depending on the needs and assessments of the organization.

In one implementation, a status measure can range from 0 to 32. If the status measure is less than or equal to 10, the status measure is considered to be red; if the status measure is greater than 10, but less than or equal to 24, the status measure is considered to be yellow, and if the status measures is greater than 24, the status measure is considered to be green. For example, if K_{Knowledge} is equal to 20, the color associated with the knowledge KPI is yellow; if K_{Penetration} is 26, the color associated with the penetration KPI is green.

Further, in this implementation, for data that is collected using the traffic light system, for example by interview, red attributes are treated as having a status measure of 4, yellow attributes are treated as having a status measure of 16, and green attributes are treated as having a status measure of 32. If a status measure is used to collect this data, the scale is divided into 33 sections, from 0 to 32, and the section of the scale that the individual has selected is used as the status measure for the KPI under consideration. Using this method to translate between traffic light colors and numerical values, a variety of calculations can be performed to determine the costs, savings, and return on investments for a particular security project.

The status measure of each KPI can be used to evaluate measures that are implemented poorly. For example, if the status measure of K_{Knowledge} is low, then the organization must gain knowledge about that particular measure. If the status measure of K_{Knowledge} is high, but K_{Readiness} is low, than the organization has the knowledge to implement the measure under consideration, but is not well prepared to do so. If the status measure of K_{Knowledge} and K_{Readiness} are high, but K_{Penetration} is low, the organization has the knowledge to implement the measure under consideration, and is prepared to do so, but the organization has not made a significant effort to actually implement the measure.

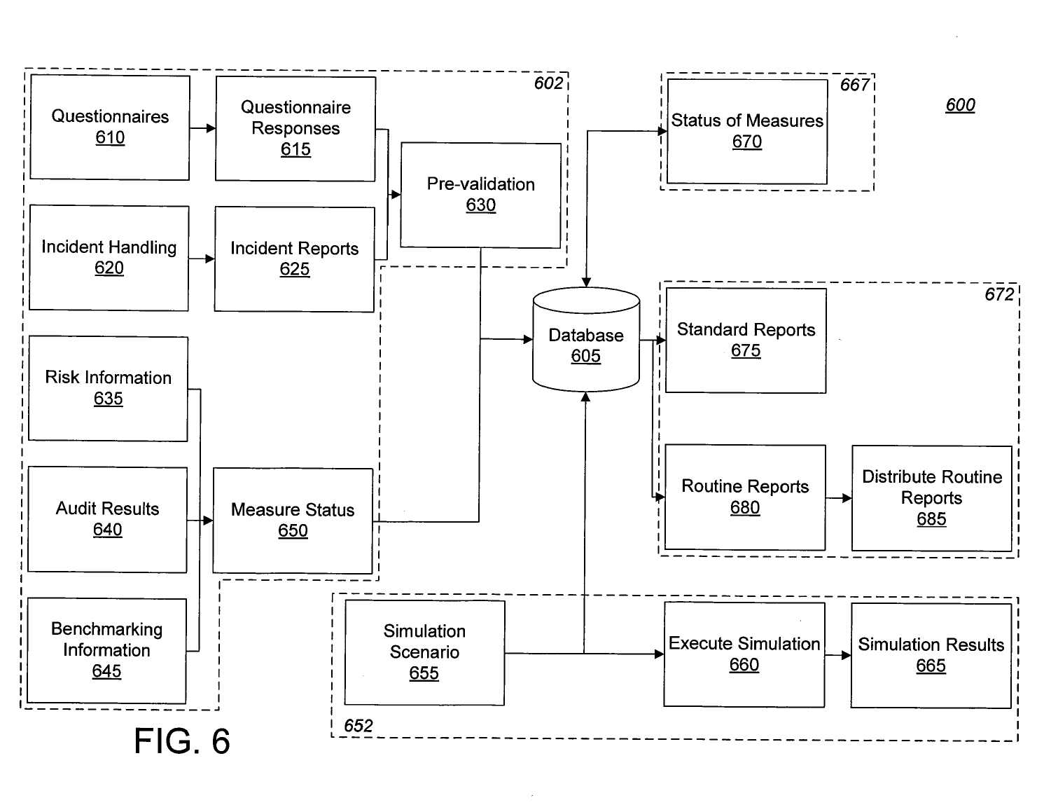

FIG. 6 illustrates a system 600 for combining and distributing information relating to the risk status of an organization. All of the information is gathered and stored in a database 605 for use in the reporting, simulation, and validation process. A data collection process 602 collects information through a variety of mechanisms. Questionnaires 610 regarding various measures can be created and distributed to various individuals within the organization. The completed questionnaire responses 615 can then be collected. In addition, an incident handling mechanism 620 can be implemented to provide fraud and security incident reports 625; the incident reports 625 are also collected. Together, the questionnaire responses 615 and incident reports 625 are pre-validated 630 and stored in the database 605. As an example of pre-validation, if for a single measure, an individual reported the status of the knowledge KPI as red, but the penetration of the KPI as green, this would fail a pre-validation test, as it is impossible to implement a measure filly about which nothing is known. Similarly, the questionnaire responses 615 and incident reports 625 can be pre-validated to determine if there are an excess of green indicators or red indicators, which could indicate a bias by the individual completing the questionnaire response or a problem with the incident reporting system. Questionnaire responses or incident reports that fail the pre-validation step can be flagged for further review and/or excluded from the database 605. Risk information 635, audit results 640, and benchmarking information 645 can be used to generate a measure status 650, which is also stored in the database 605.

A simulation process 652 allows simulations to be performed based upon the data collected during the data collection process 602. First, simulation scenarios 655 are defined or selected by a user of the system 600. Simulation scenarios can be created for, among other things, potential security projects, potential business projects, or potential changes in the environment. A simulation of a scenario can determine the influence of the project or environmental change on the status of controls, and on the value of assets. Upon the selection of a simulation scenario 655, the system 600 uses the information in the database 605 and executes the simulation 660. During the execution of the simulation 660, the new security status of assets and controls, based on the project or environmental change, is calculated and then used to determine the return on security investment as well as a residual risk. These results can then be compared with the current security status of assets and controls. After the simulation has been executed, the simulation results 665 are distributed or otherwise made available to the appropriate individuals within the organization. Further details relating to the techniques used during the simulation process 652 are discussed below.

A validation process 667 can be used to validate the status of measures 670 based on information in the database 605. As an example, the Chief Security Officer (CSO) of the organization can verify that the various reports indicating that building access controls are functioning are valid and accurate; if these reports are not accurate, the CSO can make adjustments to information contained in the database 605. The information can be presented in a summarized fashion; for example, the summarized status of assets that were affected by incidents and the current status of controls can be reported, based upon information received from audits, risk management reports, benchmarking, and reported data. Based upon these summary reports, validation decisions and adjustments to the status of particular measures can be made by the appropriate individuals, and these adjustments are then stored in the database 605.

Finally, a reporting process 672 can generate both standard and non-standard reports to various individuals. Standard reports 675 are generated, and available to the appropriate individuals within the organization. In one implementation, the standard reports 675 are available as static or dynamic web documents from a web server to appropriate individuals using conventional web browsers over secure network connections. In addition to the standard reports 675, which are always available and accessible in real-time, routine reports 680 can also be generated. Routine reports 680 are defined by individuals in the organization to contain information pertinent to a specific individual or division. For example, a routine report for the legal department can include information pertaining to regulatory requirements and risks, while a routine report to the information technology department can include information pertaining to information technology threats and risks. Based on the nature of the routine report 680, the routine report is distributed 685 or made available to the appropriate individuals or divisions.

A single loss expectancy SLE_{T,A,C} for a particular asset A in country C to a threat T can be calculated using the formula SLE_{T,A,C}=Roc_{T,A}×I_{T,A}×Ex_{T,A,C}×V_{A}, where Roc_{T,A} is the annual rate of occurrence of an incident damaging asset A caused by threat T; I_{T,A} is an impact factor for an asset A to a threat T; Ex_{T,A,C} is the exposure of asset A in country C to a threat T in comparison to the standard exposure Ex; and V_{A} is the value of the asset A expressed in dollars, euros, or other currency unit. The impact factor is defined as the portion of the asset A that is damaged due to the occurrence of a particular threat T, with I_{T,A}=0 representing no damage from the threat T to the asset A and I_{T,A}=1 representing total loss of the asset A from the threat T; each asset-threat pair can be assigned a different impact factor. The standard exposure value is Ex=1, which represents the lowest possible risk. The exposure Ex_{T,A,C} for a particular asset A in country C to a threat T can be as low as 1, equivalent to the standard exposure and representing the lowest possible risk. There is no limit to how high Ex_{T,A,C} can be. If the exposure for an asset to a threat in a country were twice as great as for a baseline asset, Ex_{T,A,C} would be 2. If it were a hundredfold greater, Ex_{T,A,C} would be 100. The exposure value can also be called a risk factor multiplier.

The effectiveness of one measure on a threat can be expressed as Eff_{T,M,C,} where Eff_{T,M,C}=(1−Raro_{T,M}×IL_{M,C})(1−RI_{T,M}×IL_{M,C}). Raro_{T,M} is the reduction of annual rate occurrence for a threat T due to a measure M, and ranges from 0 to 1, where a value of Raro_{T,M}=0 represents a completely ineffective measure M against the threat T and a value of Raro_{T,M}=1 represents a measure M that can completely prevent an incident due to threat T. IL_{M,C} is the implementation level for a particular measure M against a threat T, and also ranges from 0 to 1, where IL_{M,C}=0 indicates a measure M that is not at all implemented against a threat T and IL_{M,C}=1 indicates a measure M that is fully implemented against a threat T. RI_{T,M} is the reduction of the impact rate for a measure M against a threat T, and also ranges from 0 to 1, where RI_{T,M =}0 represents a completely ineffective measure M against a threat T, and RI_{T,M}=1 represents a measure M that will completely eliminate the damage of an incident caused by threat T.

The annual loss expectancy ALE_{A,C} for a particular asset A in country C is calculated by the formula

$${ALE}_{A , C} = {\sum }_{T} {SLE}_{T , A , C} ,$$

where SLE_{T,A,C} is calculated as shown above. The mitigated annual loss expectancy mALE_{A,C} for a particular asset A in country C is calculated by the formula

$${mALE}_{A , C} = {\sum }_{T} ( {SLE}_{T , A , C} \times {\prod }_{M} {Eff}_{T , M , C} ) ,$$

where both SLE_{T,A,C} and Eff_{T,M,C} are calculated as shown above. Once ALE_{A,C} and mALE_{A,C} are calculated, the savings S_{A,C} for a particular asset A in country C due to all measures M can be calculated as S_{A,C}=ALE_{A,C}−mALE_{A,C}. The total cost of measures TCO_{A,C} for all measures M relevant to an asset A is calculated as

$${TCO}_{A , C} = {\sum }_{M} {Cost}_{M , A , C} ,$$

where Cost_{M,A,C} is the cost of a particular measure M to protect an asset A in country C.

The return on security investment ROSI_{A,C} for an asset A in country C is ROSI_{A,C}=S_{A,C}−TCO_{A,C} which can also be expressed as ROSI_{A,C}=ALE_{A,C}−mALE_{A,C}−TCO_{A,C}. Expressed as a percentage, the return on investment (“ROI”) can be calculated using the formula

$$ROI = ( \frac{{ROSI}_{A , C}}{TCO} - 1 ) \times 100.$$

These calculations can also be used to determine the effectiveness of simulated measures, in order to determine whether or not it is worthwhile to implement a new measure Mnew. The mitigated annual loss expectancy for all existing measures M in place, mALE₁, is calculated as

$${mALE}_{1} = {\sum }_{A} {\sum }_{C} {mALE ( M )}_{A , C} .$$

### The mitigated annual loss expectancy for all existing measures M in place plus one new measure Mnew being simulated, mALE₂, is calculated as

$${mALE}_{2} = {\sum }_{A} {\sum }_{C} {mALE ( M ⋃ \{ Mnew \} )}_{A , C} .$$

The total cost of ownership (“TCO”), for the new measure being simulated, Mnew, is equal to the cost of the new measure, C_{Mnew}. The savings S_{Mnew} resulting from the new measure Mnew can be simulated using the formula S_{New}=mALE₁−mALE₂; the return on security investment for the new measure Mnew can be simulated using the formula ROSI_{Mnew}=S_{New}−TCO; this formula can also be expressed as ROSI_{Mnew}=mALE₁−mALE₂−C_{Mnew}. Therefore, the return on investment for this new measure Mnew being simulated can be calculated by the formula

$$ROI = ( \frac{{ROSI}_{Mnew}}{{C}_{Mnew}} - 1 ) \times 100.$$

The implementation level, IL_{M,Rep(C,D)}, for a particular measure M in a single report Rep(C, D) covering a single county C and a single division D can be expressed as

$${IL}_{M , Rep ( C , D )} = \frac{{\sum }_{Type} ( {Kw}_{Type} \times {K}_{Type , M , Rep ( C , D )} )}{{\sum }_{Type} {Kw}_{Type}} .$$

As described above, Kw_{Type} is a weighting value for each type of KPI, and K_{Type,M,Rep(C,D)} is the KPI value for each type of KPI for a measure M and Report Rep(C,D) covering a single country C and a single division D. The implementation level, IL_{M,C}, for a particular measure M in a single country C, but across several divisions can be expressed as

$${IL}_{M , C} = \frac{{\sum }_{D} ( {IL}_{M , Rep ( C , D )} \times {Dw}_{D} )}{{\sum }_{D} {Dw}_{D}} .$$

### Dw_{D} is a weighting factor Dw for division D.

The relevance R_{M} of a measure M can be calculated as

$${R}_{M} = \frac{{\sum }_{A , C} ( {Ex}_{A , C} \times W {sec}_{A , M} \times {Mw}_{M} )}{{\sum }_{A , C} {Ex}_{A , C} \times {\sum }_{A} W {sec}_{A , M}} .$$

Mw_{M} is a measure weighting value Mw for a measure M. Ex_{A,C} is the exposure of asset A in country C to all threats; Ex_{A,C} is expressed in relation to a standard exposure value, Ex, as described above. In addition, the exposure of an asset A to all threats in all countries, Ex_{A}, can be calculated as

$${Ex}_{A} = \frac{{\sum }_{C} ( {Ex}_{A , C} \times {R}_{C} )}{{\sum }_{C} {R}_{C}} .$$

The implementation level IL_{M} of one measure M across all countries can be calculated as

$${IL}_{M} = \frac{{\sum }_{C} ( {IL}_{M , C} \times {R}_{M , C} )}{{\sum }_{C} {R}_{M , C}} .$$

### Similarly, the implementation level IL_{C} of all measures in a single country C can be calculated as

$${IL}_{C} = \frac{{\sum }_{M} ( {IL}_{M , C} \times {R}_{M , C} )}{{\sum }_{M} {R}_{M , C}} .$$

### From either of these calculations, the implementation level IL of all measures across all countries can be

calculated as either

$$IL = \frac{{\sum }_{M} ( {IL}_{M} \times {R}_{M} )}{{\sum }_{M} {R}_{M}} or IL = \frac{{\sum }_{C} ( {IL}_{C} \times {R}_{C} )}{{\sum }_{C} {R}_{C}} .$$

Error calculations can also be performed in order to determine the accuracy of the information generated by the above formulae. The average implementation level for a measure, I̅L̅, can be calculated as

$$\overline{IL} = \frac{{\sum }_{i = 1}^{n} {IL}_{i}}{n} .$$

### Similarly, the absolute range of implementation levels, Δ I̅L̅, can be calculated as

$$Δ \overline{IL} = \frac{( ( \overline{IL} - {IL}_{min} ) + ( {IL}_{max} - \overline{IL} ) )}{2} .$$

Approximating

$$\frac{Δ {ROSI}_{A , C}}{Δ \overline{IL}}$$

by the partial derivative

$$\frac{\partial {ROSI}_{A , C}}{\partial \overline{IL}}$$

and evaluating it, the absolute range of the return on security investment ROSI_{A,C} for an asset A in country C can be derived as

$$Δ {ROSI}_{A , C} = Δ \overline{IL} \times {\sum }_{M} {\sum }_{T} Roc \times I \times Ex \times V \times ( Raro \times ( 1 - RI \times \overline{IL} ) + RI \times ( 1 - Raro \times \overline{IL} ) )$$

Similar calculations can be applied to determine the security status of a particular asset, as well as of a group of assets; the remaining security risks for a single asset or a group of assets; the security status of business processes; and the security status of an entire organization or particular divisions within the organization. In addition, further calculations can be undertaken to simulate the impact of a project on all of these measures, as well as to simulate the impact of changes in the environment to all of these measures.

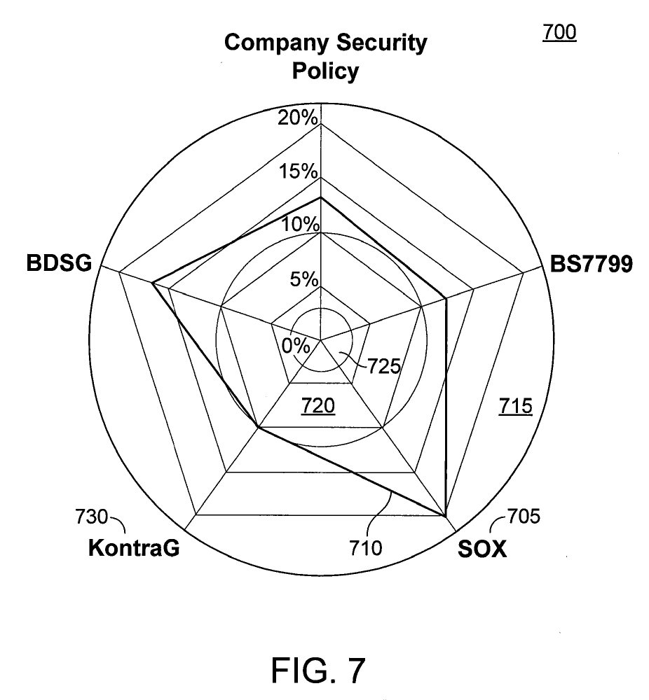

FIG. 7 illustrates a first method of displaying to a computer user the status of implementation of security measures related to regulatory requirements. Each regulatory requirement is represented as a spoke. For example, the regulatory requirements of SOX are represented by spoke 705. The heavy line 710 provides a visual representation of the percentage of measures related to regulatory requirements that are not likely to have been sufficiently implemented. The percentage of measures related to regulatory requirements that are not likely to have been sufficiently implemented is determined based upon the input received by the reporting system, e.g., by interviews of various individuals within the organization. In the example presented in FIG. 7, approximately 21 percent of the measures relating to SOX are not likely to have been sufficiently implemented.

FIG. 7 also illustrates how the traffic light system can be used to provide guidance to an organization. The outer ring 715 represents the red zone, the middle ring 720 represents the yellow zone, and the inner ring 725 represents the green zone. The spoke 705 representing the regulatory requirements of SOX shows that the organization is in the red zone, indicating that the organization has additional work to perform in order to implement measures bringing it into compliance with the SOX regulations. The spoke 730 representing the regulatory requirements of KonTraG shows that the organization is in the yellow zone, indicating that the organization is making decent progress in implementing measures bringing it into compliance with the KonTraG regulations, but still has additional measures that need to be fully implemented. The ultimate goal for the organization is to have all of its requirements fall within the green zone, indicating that only a minimal number of measures are not yet sufficiently implemented.

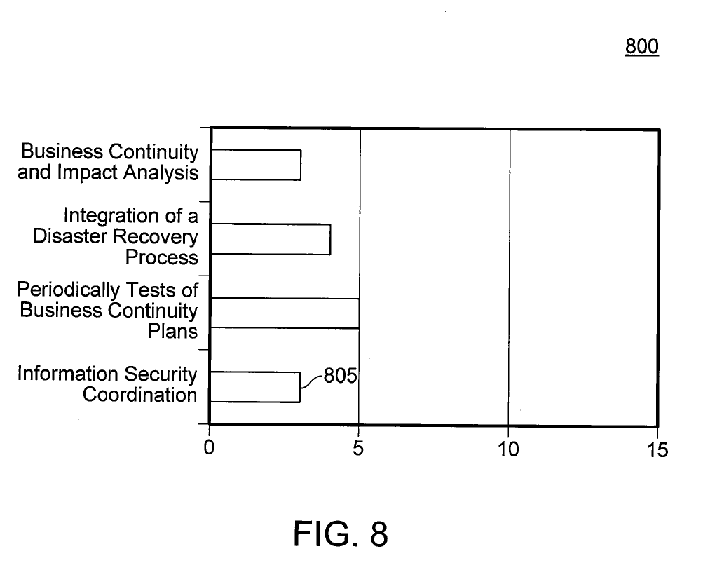

FIG. 8 illustrates a second display 800 of information about security measures related to regulatory requirements. In this view, additional information is provided about each measure associated with a particular regulation, and the number of requirements associated with that measure that are likely not fully fulfilled. For example, measure 805 is information security coordination. According to this display, approximately three requirements relating to measure 805 are not likely to have been fulfilled.

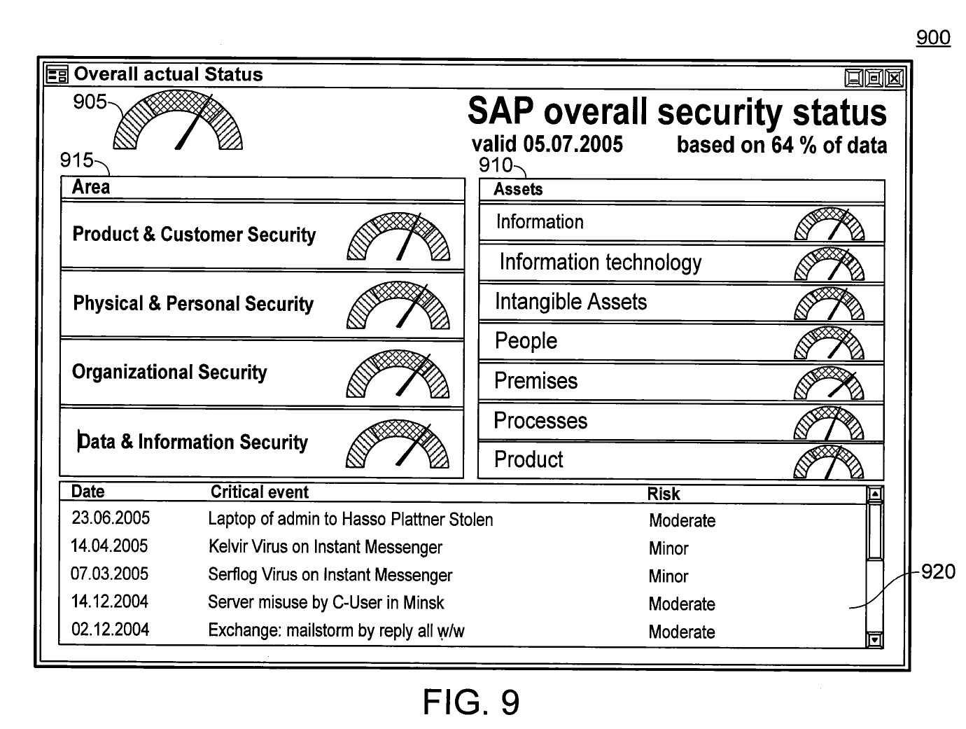

FIG. 9 illustrates a computer-generated display 900 of a snapshot view of the security status of an organization. The status of various aspects of the security status is presented in a speedometer format, with a needle indicating whether a particular metric falls within the red, yellow, or green zone of the traffic light system. The overall security status 905 indicates that the organization falls within the middle, or yellow, level. This indicates that the organization is making progress towards fully implementing adequate measures to protect its assets, but still has a ways to go. However, the speedometer showing the overall security status 905 also shows that the organization is relatively close to the green zone, indicating that as long as progress continues towards implementing the various measures, the organization can expect to reach green status.

In addition, multiple speedometers in the security snapshot indicate the status of security relating to various types of assets 910, as well as the security associated with different divisions 915. Various critical security events 920, as well as the level of risk associated with each security event, are also displayed in the security snapshot.

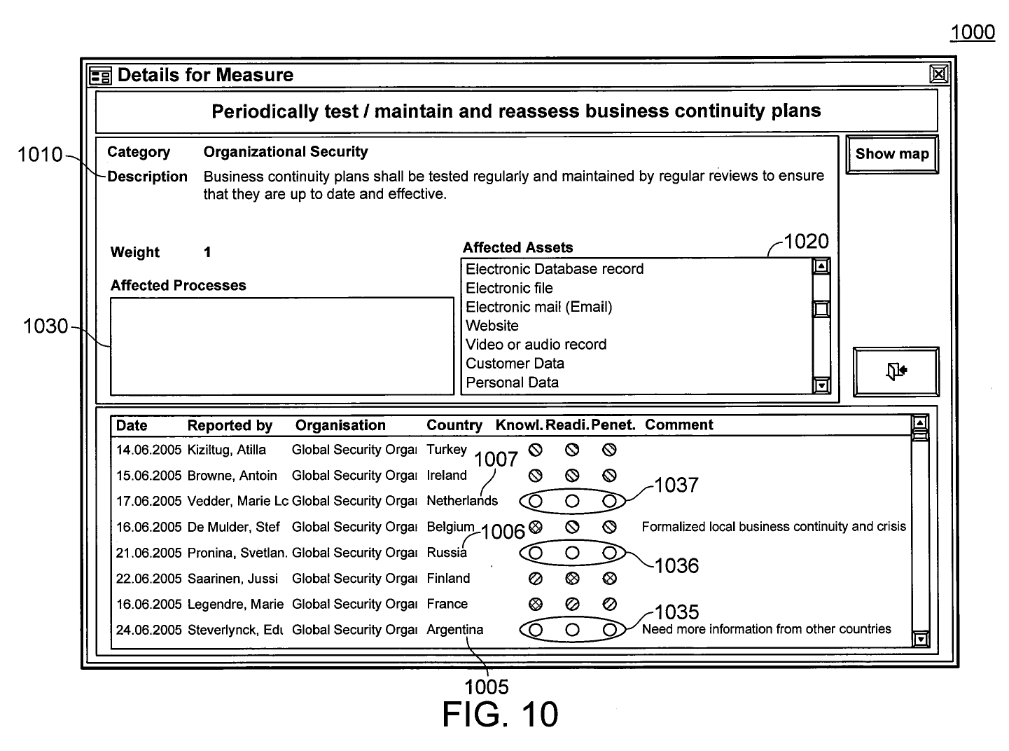

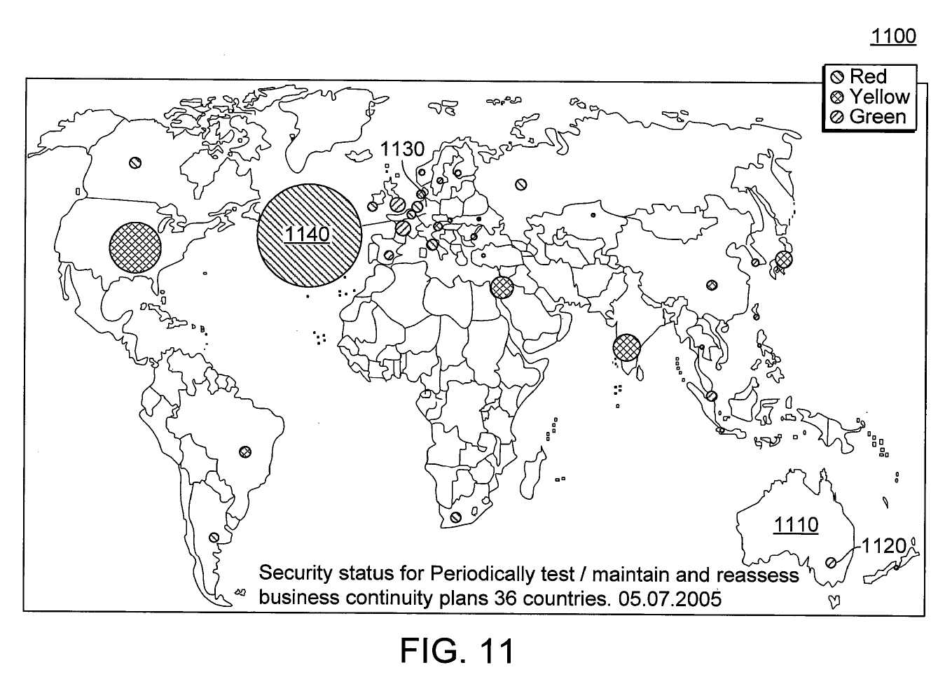

FIG. 10 illustrates a computer-generated display 1000 of information providing further details about a particular measure with regards to each country in which the organization has a presence. Here counties include Argentina 1005, Russia 1006, and the Netherlands 1007. A description 1010 of the measure, assets 1020 that are affected by the measure, processes 1030 that are affected by the measure, as well as the traffic signal status of each KPI for each country are displayed. Here the assets 1020 include website and personal data. The traffic signal status 1035 for Argentina 1005 is indicated. The same is true for the traffic signal status 1036 for Russia 1006 and the traffic signal status 1037 for the Netherlands 1007. Alternatively, this same information can also be displayed in a graphical format overlaid on a map 1100, as shown in FIG. 11.

In FIG. 11, the color of the circle indicates the overall status of this measure for a particular country, and the size of the circle indicates the proportion of assets affected by this measure that are allocated to that particular country. For example, although Australia 1110 has a green traffic light status of the circle 1120 with regards to this measure, the size of the circle 1120 indicates that only a small proportion of the organization's assets affected by this measure are located in Australia. By contrast Germany 1130, which is geographically smaller than Australia 1110, has a much larger circle 1140 than Australia's circle 1120, indicating that a large proportion of the organization's assets affected by this measure are located in Germany.

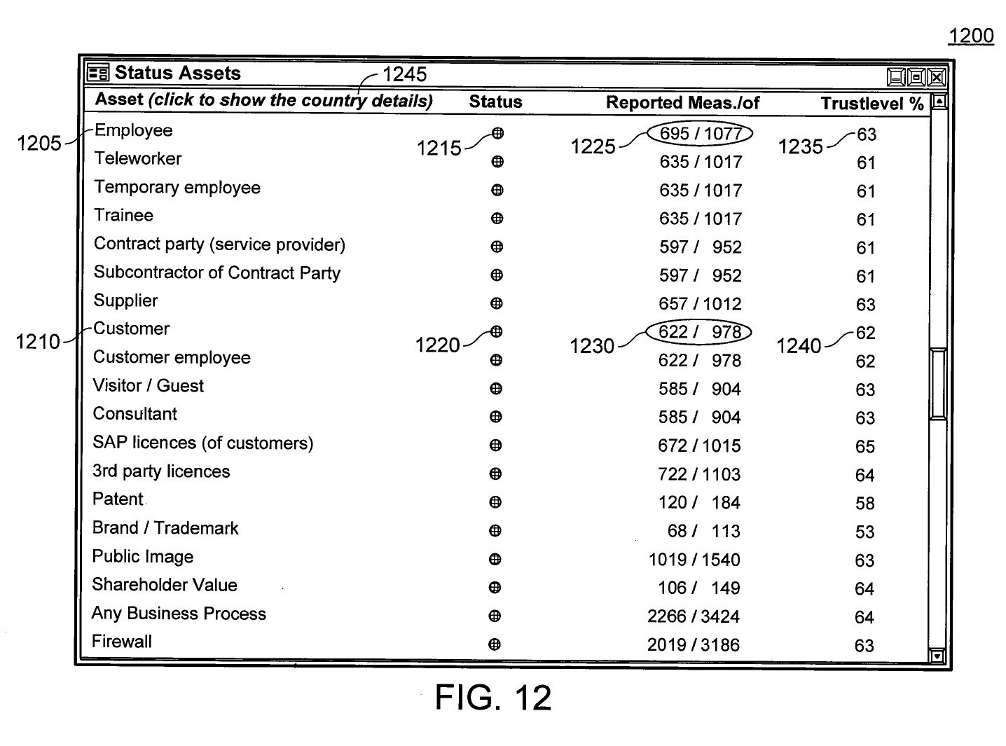

FIG. 12 illustrates a computer-generated display 1200 of information detailing the global status of particular assets within the organization. Here assets include employees 1205 and customers 1210. Traffic light statuses correspond to the assets; here the status 1215 for employees 1205 and the status 1220 for customers 1210 are both green. In addition to the traffic light status for each asset, the number of reported measures for a particular asset can be displayed. Here for employees 1205, 695 of 1077 possible measures 1225 have been reported. For customers 1210, 622 of 978 possible measures have been reported 1230. A confidence, or trust level, can be computed for the reported measures. For employees 1205 the trust level 1235 is 63%, and for customers 1210 the trust level 1240 is 62%. The user can be informed 1245 that he may click on the assets to show asset details by country.

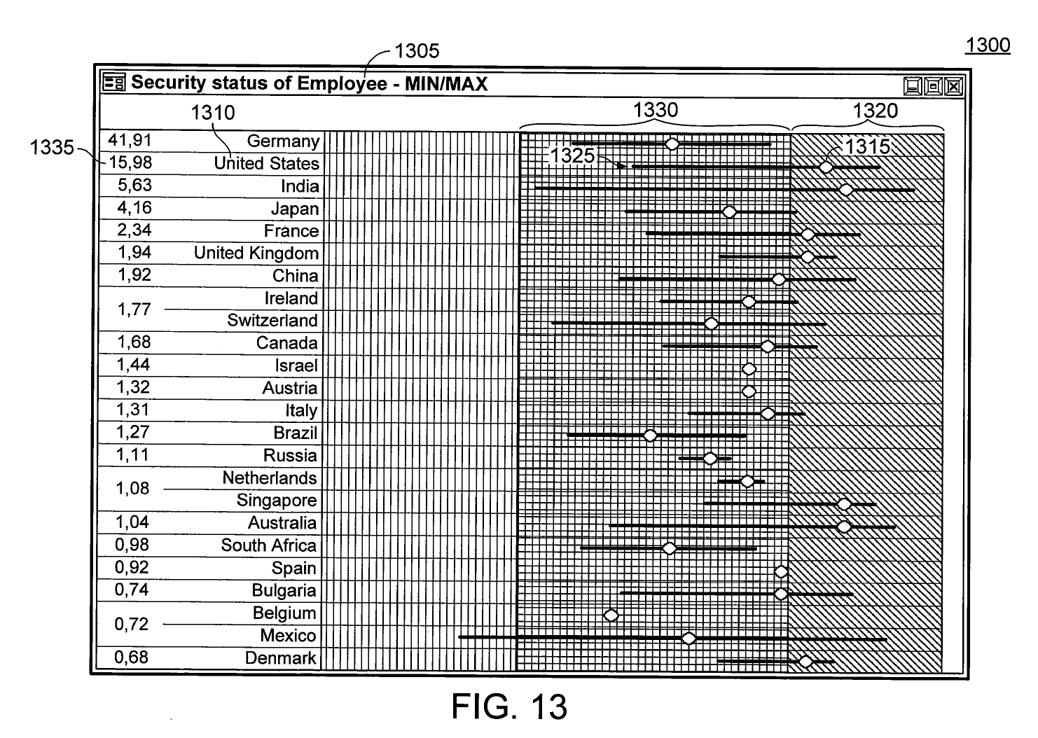

FIG. 13 illustrates a computer-generated display 1300 showing further detail about the status of a particular asset; in this instance, the status of the asset is shown for each country. In this view, a confidence band is displayed for the status of the asset in each county. For example, the status of the employee asset 1305 in the United States 1310 is green, as indicated by the dot 1315 falling in the rightmost zone 1320. However, the confidence band 1325 extends into the central yellow zone 1330, because not all of the measures relating to the employee asset have been reported, and it is possible that the true status of this asset within the United States is yellow, rather than green. In addition, the number to the left of each country 1335 represents the percentage of the total asset that is located in that particular country. This information relating to the status of one or more assets can also be displayed as a map-based graphical format, similar to that shown in FIG. 11.

The confidence interval of the average IL implementation level can be calculated with standard statistics. First the unbiased standard deviation is estimated.

$$s = \sqrt{\frac{1}{n - 1} {\sum }_{i = 1}^{n} {( {x}_{i} - \overline{x} )}^{2}} .$$

### Then the standard error is estimated.

$$SE = \frac{2}{\sqrt{n}} .$$

The 90% confidence band is then: x̅±1.64×SE.

The confidence interval can also be calculated with best-case worst-case calculations, where the lower bound is calculated assuming that many or all of the unreported measures are negative and the upper bound is calculated by assuming that many or all of the unreported measures are positive.

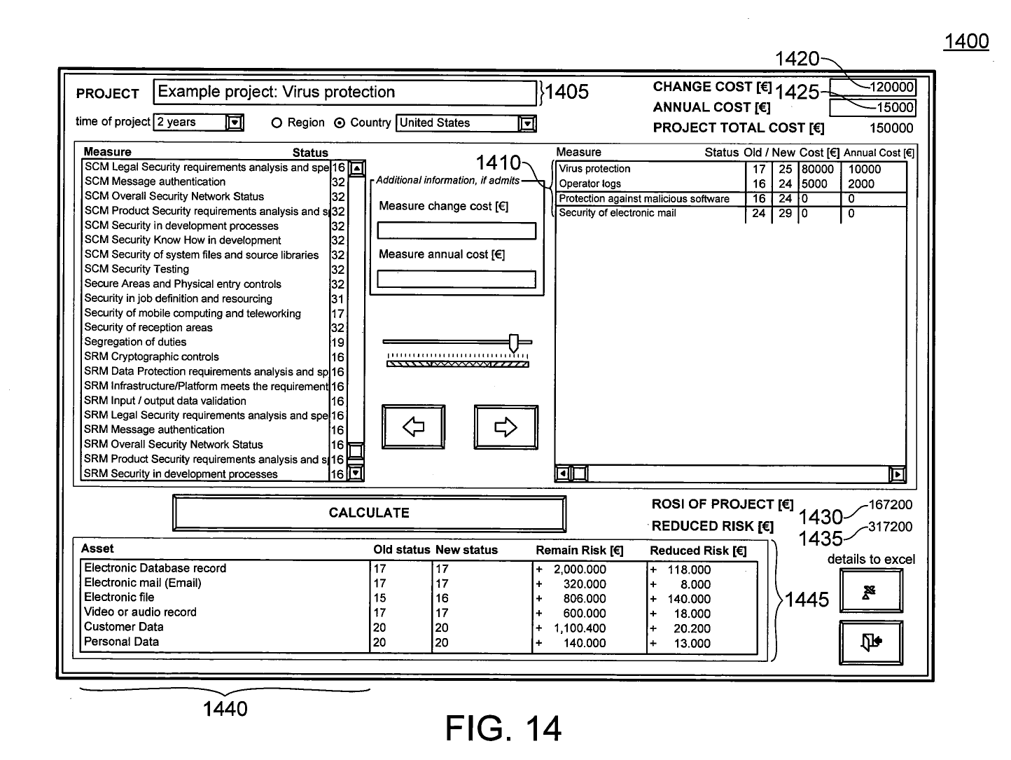

FIG. 14 shows an example of a form 1400 that can be used to run a simulation of a proposed project 1405, here “virus protection.” This form allows an individual to simulate a project by determining the measures 1410 that will be affected by the proposed project 1405 and entering revised values for the status of each of these measures. Here, the affected measures 1410 include virus protection and operator logs. In addition, if any new measures are implemented due to the proposed project, these can be entered by the individual as well. The user also enters the costs of implementing the proposed project 1420, as well as any annual recurring costs that will be incurred due to the proposed project 1425. The system can then use these entries to simulate the proposed project and calculate a return on investment 1430 for a proposed project, as well as the aggregate value attributable 1435 to the reduced risk to the organization's assets 1440 because of this proposed project. The value attributable can be broken down by asset 1445 as well as shown as an aggregate 1435. This allows decision makers to select projects that will have the best return on investment and greatest impact on the protection of the organization's assets.

In one implementation, assets that require protection are identified. For example, assets requiring protection can include confidential data, e.g., customer or order databases, web pages, web site availability, or tangible assets such as buildings and computers. All of the assets of a particular business process can be categorized based on a predefined rule set.

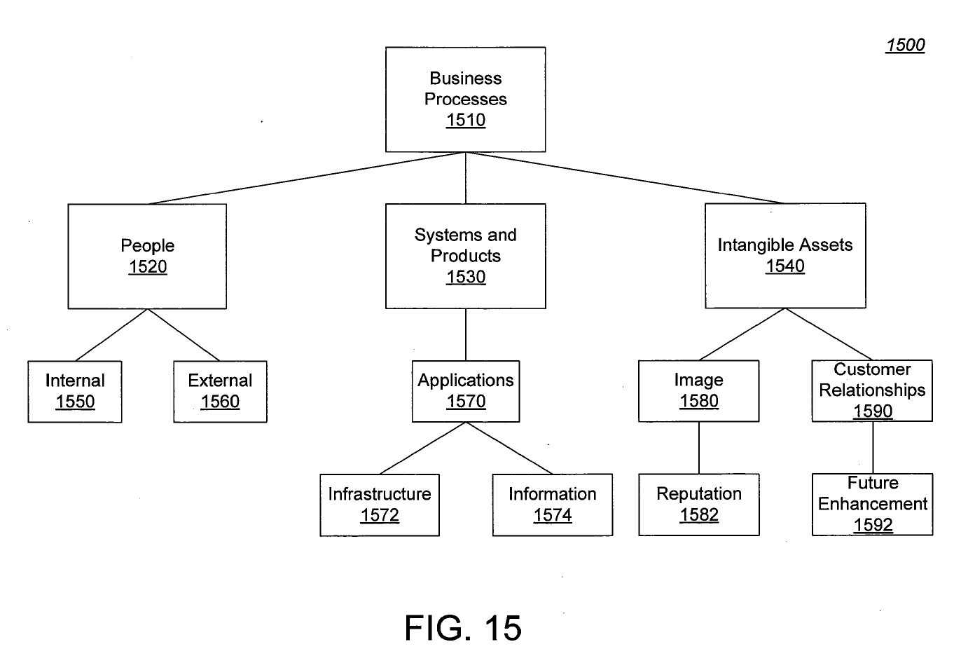

In one implementation, the assets can be categorized using a layered business process. FIG. 15 illustrates an exemplary layer structure 1500 for a set of assets. Under the business process 1510, there are three categories of assets: people 1520, systems and products 1530, and intangible assets 1540. These three categories can be further broken down. For example, the category people 1520 can be divided into internal people 1550 and external people 1560. Systems and products 1530 can be broken down into applications 1570 and further into infrastructure 1572 and information 1574. Similarly, intangible assets 1540 can be subdivided into image 1580 and customer relations 1590. In turn image 1580 can be further categorized as reputation 1582, and customer relationships 1590 can be further categorized as future enhancement 1592 of the relationships. The use of the layered structure to identify assets can assist in identifying assets that might otherwise be unidentified.

In addition, for each asset that involves information (either the informational assets or assets that store or contain informational assets), the values of various attributes associated with the informational asset can be taken into consideration. These attributes can include confidentiality (i.e., preserving authorized restrictions on access and disclosure), integrity (i.e., guarding against improper modification), and availability (i.e., ensuring timely and reliable access and use). In the end, a general threat rating for each asset can be established based on the values for each of the attributes.

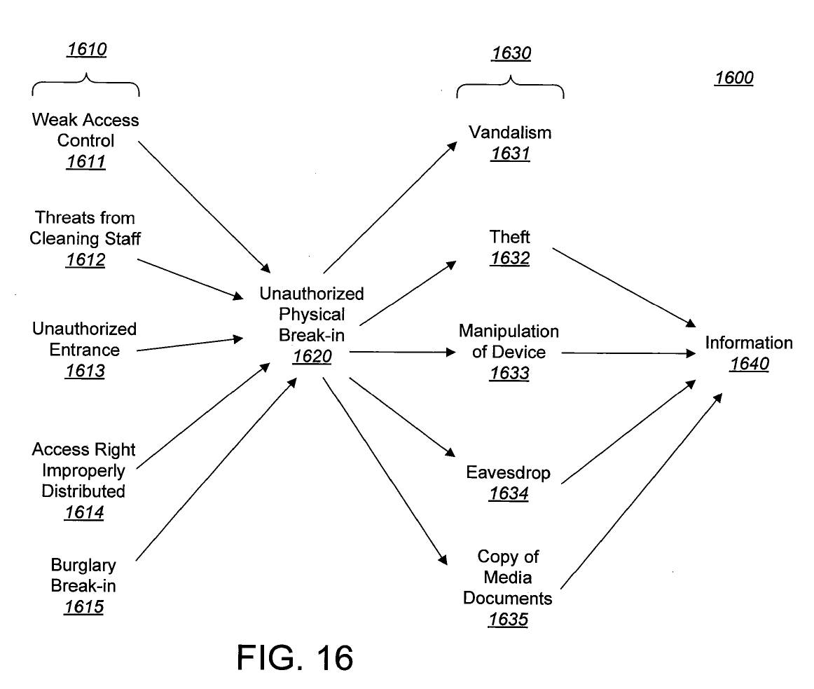

FIG. 16 illustrates a hybrid goal-based and trigger-based approach 1600 to identifying threats to the enterprise. The triggers 1610 are specific threat breaches which could trigger a generic threat breach 1620 leading through actions 1630 to a threat “goal” 1640. In this example any number of specific threats could lead to an unauthorized physical break-in 1620, such as weak access control 1611, threats from cleaning staff 1612, unauthorized entrance to a building 1613, access rights being improperly distributed 1614, or burglary break-in 1615. Once an intruder achieves unauthorized building access 1620, he might vandalize property 1631, steal property 1632, manipulate some device 1633, eavesdrop 1634, or copy media documents 1635. Most of those actions lead to the intruder acquiring information 1640, his goal. However, vandalism 1631 would not lead to the intruder gaining information, even though it would originate from the same kind of specific threat breach. The hybrid approach 1600 allows security officers to characterize the threats to their enterprise having common causes or consequences.

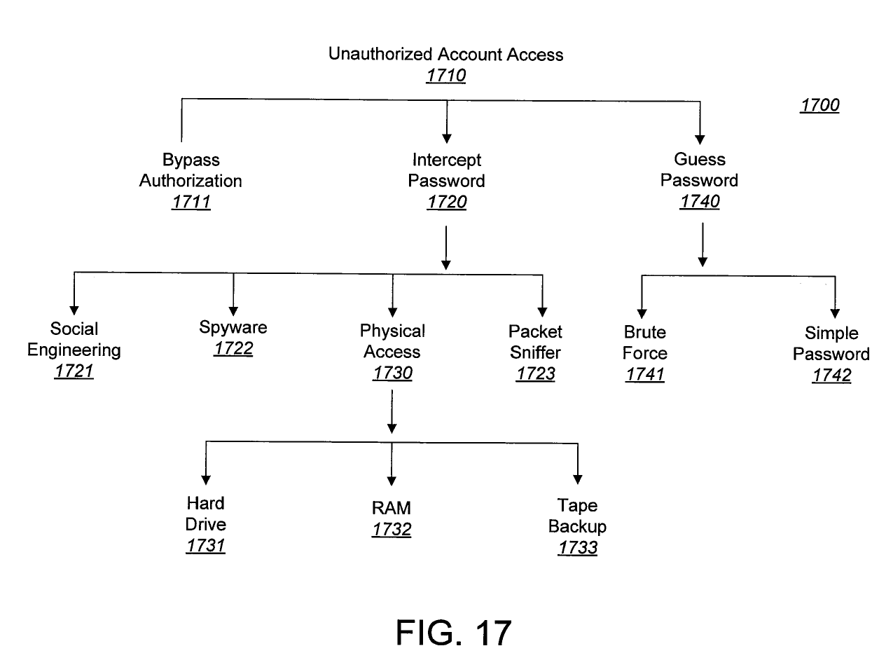

FIG. 17 is a threat tree 1700 that can be used for identifying threats to the enterprise. Here the generic threat breach unauthorized account access 1710 has several possible causes. Authorization might be bypassed 1711, a password might be intercepted 1720, or the password might be guessed 1740. These causes might have sub-causes, for instance a password could be intercepted through social engineering 1721, spyware 1722, physical access 1730, or a packet sniffer 1723. Physical access in turn could be through the hard drive 1731, random-access memory 1732, or tape backup 1733. A password might be guessed either through brute force 1741 or because it was too simple and therefore easily guessed 1742. There can be any number of levels of causes and sub-causes which result in threats to the enterprise.

Having identified threats as illustrated in FIG. 16 and FIG. 17, estimates can be made of the likelihood of the various threats. An event might be estimated to occur multiple times per day, once every few months, once a year, or once every twenty years. By combining estimates of the likelihood of various threats with the estimated impact, the cost of various threats can be estimated. Similarly, by estimating risk reduction, the value of various measures can be estimated, and then displayed as in field 1445 (FIG. 14).

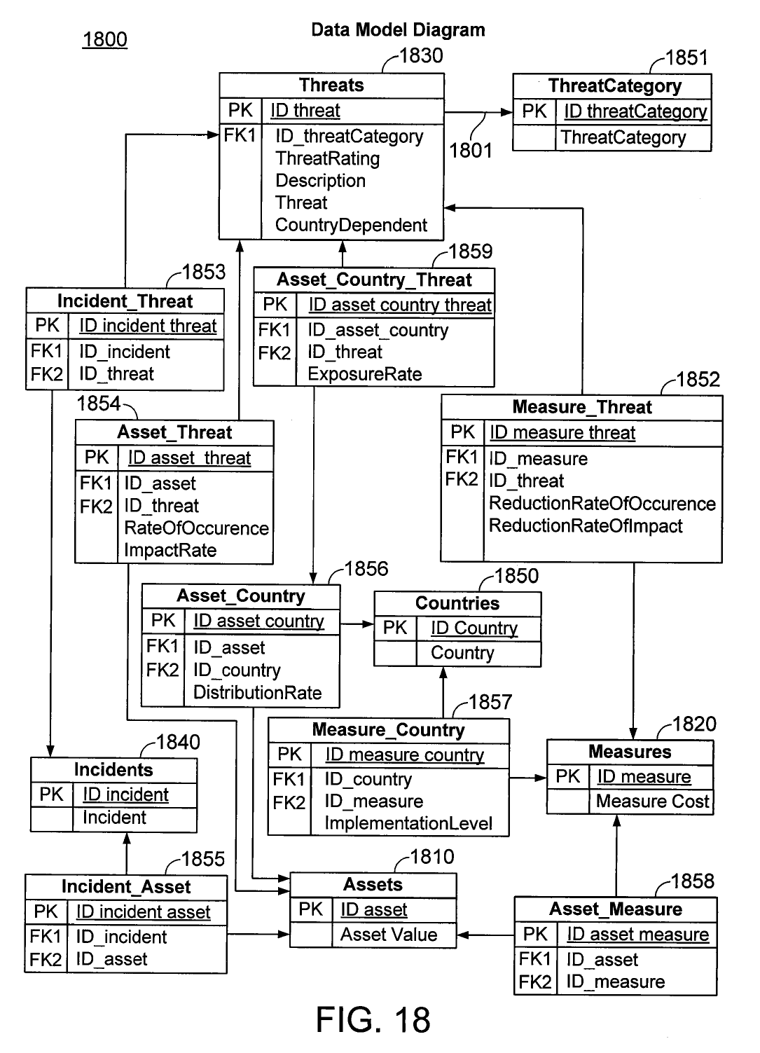

FIG. 18 is a table diagram 1800 for the asset-threat-measure database, in a standard notation known to database designers where arrows 1801 are used to show a foreign-key relationship. A foreign key is a reference in one table to the key of another table. Through standard database normalization techniques, a few tables, like Assets 1810, Measures 1820, Threats 1830, and Incidents 1840 store “master data” which does not depend on other data. A few small helper tables store things like country names 1850 or threat categories 1851 to ensure self-consistency in the database. The foreign key relationship ensures, for example, that country names are not misspelled or entered in alternate forms, such as U.S. or America instead of U.S.A. Other tables hold “derived data” which define a many-to-many relationship between other tables. This standard technique of database design, for example, uses a Measure-Threat table 1852 to indicate that any one measure can mitigate multiple threats, and any one threat can be mitigated by multiple measures. These derived-data tables, such as the Measure-Threat table 1852, may contain other data besides the foreign keys. The Measure-Threat table 1852 also includes Reduction-Rate-Of-Occurrence and Reduction-Rate-Of-Impact fields, which store how much a particular measure reduces the rates of occurrence and impact of a particular threat.

Other tables defining a many-to-many relationship include the Incident-Threat table 1853, reflecting that many threats can be involved in causing a single incident and that a single threat can cause many incidents. Another is the Asset-Threat table 1854, reflecting that many threats can threaten a single asset and that a single threat can threaten many assets. Another is the Incident-Asset table 1855, reflecting that a single incident can involve many assets and that a single asset can be involved in many incidents. Another is the Asset-Country table 1856, reflecting that an asset (e.g. employees or computers) can be present in many countries and that a country can contain many assets. Another is the Measure-Country table 1857, reflecting that many measures can be in effect in a single country and that a single measure can be in effect in many countries. Another is the Asset-Measure table 1858, reflecting that many assets can be protected by a single measure and that a single asset can be protected by many measures. Another is the Asset-Country-Threat table 1859, reflecting that assets in a particular country can be affected by many threats, and a single threat can threaten assets in multiple countries.

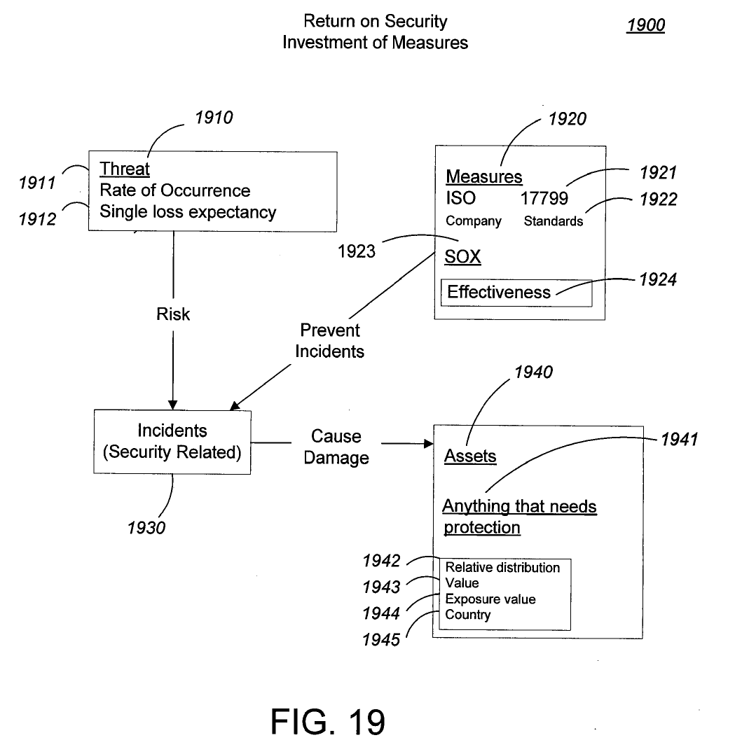

FIG. 19 illustrates a relation 1900 between data objects which may be used in one implementation of the Return on Security Investment calculation model. Threats 1910 pose a danger to assets 1940 and have the capability of damaging them by causing an incident 1930. Measures 1920 mitigate incidents.

The data structure may be organized in an asset centric manner. Assets 1940 are tangible objects such as buildings, computers, or people and intangible objects such as information or reputation and can be anything that needs protection 1941. Rather than including every instance of every asset, such as each laptop computer, a single data point can represent all laptops in a single country. The data point can show much of the asset is in a particular country, e.g., 30% of laptops are in Germany, as a relative distribution number 1942 and country 1945. The value of the asset 1943 may be included, for instance, laptops in America may average $2000 in value. Also, for each asset-country the exposure factor 1944 may be included. For instance, laptops may be more likely to be stolen in America than in Japan, in which case the exposure factor for laptops in America would be higher. A different geographic or political unit than “country” may be used to group instances of assets, such as company department, city, state, or province.

Measures 1920 can have one or two effects on a threat. Measures can be preventative or curative, where preventative measures may include procedures and guidelines 1921-1923, audits, firewalls and intrusion detection, virus and content scanning, and encryption. Preventative measures include standards like ISO 17799 1921, company standards 1922, or Sarbanes-Oxley 1923. Curative measures may include redundant systems and backup regimes. Measures may be both preventative and curative, for example employee training. The effectiveness of a measure 1924 can be a coefficient of preventing incidents (for a preventative measure) or reducing damage after an incident (for a curative measure).

Threats 1910 create the risk of security related incidents 1930. Various threats have different rates of occurrence 1911 for different assets. The single loss expectancy 1912 of a threat varies by country and asset. It is the expected loss of an asset in a country from a single identified threat.

The invention and all of the functional operations described in this specification can be implemented in digital electronic circuitry, or in computer software, firmware, or hardware, including the structural means disclosed in this specification and structural equivalents thereof, or in combinations of them. The invention can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the invention, can be performed by one or more programmable processors executing one or more computer programs to perform functions of the invention by operating on input data and generating output. The processes and logic flows can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component (e.g., a data server), a middleware component (e.g., an application server), or a front-end component (e.g., a client computer having a graphical user interface or a Web browser through which a user can interact with an implementation of the invention), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments, but other embodiments can be implemented and are within the scope of the following claims. Many of the operations described above can be performed in a different order and still achieve desirable results. In certain implementations, multitasking and parallel processing may be advantageous. Different mathematical formulas can be used to achieve identical or substantially similar results. Different numbers of levels can be used for presentation and acquisition of information. For example, for some organizations or parts of organizations a two-level representation may be sufficient; for others, the use of more than three levels can offer advantages. In addition, this methodology of associating measures with threats and threats to assets can be used for the management of risks that are not related to security issues, such as business risks, financial risks, etc. Other embodiments are within the scope of the following claims.

What is claimed is:

1. A computer program product, tangibly embodied in an information carrier, for a knowledge processing system, the computer program product being operable to cause data processing apparatus to:
receive asset data representing a set of assets, the asset data including a respective value for each asset in the set of assets having a value;
receive threat data representing a set of threats; each threat in the set of threats potentially reducing the value of one or more of the assets in the set of assets;
receive requirements data representing one or more requirements, wherein each requirement requires compliance with a regulation and a failure to satisfy the requirement constitutes a threat additional to the set of threats;
receive measures data representing a set of measures; each measure in the set of measures protecting the value of one or more assets from the additional one or more threats of failing to satisfy the one or more requirements; and
calculate a current status using the measures data and the requirements data based on a level of compliance with the requirements, the level of compliance determined by the measures and the additional one or more threats to one or more assets represented by the measures data and the requirements data.

2. The computer program product of claim 1, the computer program product being further operable to cause data processing apparatus to:
receive project data representing a proposed project, the proposed project modifying the set of measures by adding additional measures to the set of measures or enhancing one or more measures in the set of measures or both;
calculate a return on investment of the proposed project based on the modified set of measures and the additional threat.

3. The computer program product of claim 1, wherein the current status is represented by a percentage value, with 100 percent representing full compliance with the one or more requirements and 0 percent indicating no compliance with the one or more requirements.

4. The computer program product of claim 3, the computer program product being further operable to cause data processing apparatus to:
display the current status graphically, wherein a group of sets of one or more requirements is displayed as a group of corresponding radial spokes from a center, wherein the percentage of compliance for each set of requirements is represented as distance from the center along the corresponding radial spoke.

5. The computer program product of claim 1, the computer program product being further operable to cause data processing apparatus to:
display the current status graphically, wherein the current status is indicated by one of the following colors: red, indicating no compliance or a low level of compliance; yellow, indicating a medium level of compliance; and green, indicating a high level of compliance or full compliance.

6. The computer program product of claim 1, the computer program product being further operable to cause data processing apparatus to:
display the current status graphically, wherein a map of geographic regions is displayed graphically and the current status for each geographic region is indicated by one of the following colors: red, indicating no compliance or a low level of compliance; yellow, indicating a medium level of compliance; and green, indicating a high level of compliance or full compliance.

7. The computer program product of claim 6, the computer program product being further operable to cause data processing apparatus to:
display the current status color for each geographic region in a separate geometric shape, wherein the size of the geometric shape varies according to the relative importance of the geographic region.

8. The computer program product of claim 1, the computer program product being further operable to cause data processing apparatus to:
generate a report, the report indicating the level of compliance with the one or more requirements.

9. The computer program product of claim 8, wherein:
the report is organized by asset.

10. The computer program product of claim 8, wherein:
the report is organized by employees in various countries.

11. A computer program product, tangibly embodied in an information carrier, for a knowledge processing system, the computer program product being operable to cause data processing apparatus to:
receive user input defining specific threat triggers;
receive user input defining a generic threat trigger corresponding to the specific threat triggers; and
receive user input defining specific means by which the generic threat could be carried out.

12. The computer program product of claim 11, the computer program product being further operable to cause data processing apparatus to:
receive user input defining a goal of an intruder utilizing the specific means.

13. A computer-implemented method comprising:
receiving asset data representing a set of assets, the asset data including a respective value for each asset in the set of assets having a value;
receiving threat data representing a set of threats; each threat in the set of threats potentially reducing the value of one or more of the assets in the set of assets;
receiving requirements data representing one or more requirements, wherein each requirement requires compliance with a regulation and a failure to satisfy the requirement constitutes a threat additional to the set of threats;
receiving measures data representing a set of measures; each measure in the set of measures protecting the value of one or more assets from the additional one or more threats of failing to satisfy the one or more requirements; and
calculating a current status using the measures data and the requirements data based on a level of compliance with the requirements, the level of compliance determined by the measures and the additional one or more threats to one or more assets represented by the measures data and the requirements data.

14. The method of claim 13, further comprising:
receiving project data representing a proposed project, the proposed project modifying the set of measures by adding additional measures to the set of measures or enhancing one or more measures in the set of measures or both;
calculating a return on investment of the proposed project based on the modified set of measures and the additional threat.

15. The method of claim 13, wherein the current status is represented by a percentage value, with 100 percent representing full compliance with the one or more requirements and 0 percent indicating no compliance with the one or more requirements.

16. The method of claim 13, further comprising:
displaying the current status graphically, wherein the current status is indicated by one of the following colors: red, indicating no compliance or a low level of compliance; yellow, indicating a medium level of compliance; and green, indicating a high level of compliance or full compliance.

17. The method of claim 13, further comprising:
generating a report, the report indicating the level of compliance with the one or more requirements.

18. A system comprising:
means for receiving asset data representing a set of assets, the asset data including a respective value for each asset in the set of assets having a value;
means for receiving threat data representing a set of threats; each threat in the set of threats potentially reducing the value of one or more of the assets in the set of assets;
means for receiving requirements data representing one or more requirements, wherein each requirement requires compliance with a regulation and a failure to satisfy the requirement constitutes a threat additional to the set of threats;
means for receiving measures data representing a set of measures; each measure in the set of measures protecting the value of one or more assets from the additional one or more threats of failing to satisfy the one or more requirements; and
means for calculating a current status using the measures data and the requirements data based on a level of compliance with the requirements, the level of compliance determined by the measures and the additional one or more threats to one or more assets represented by the measures data and the requirements data.

19. The system of claim 18, further comprising:
means for receiving project data representing a proposed project, the proposed project modifying the set of measures by adding additional measures to the set of measures or enhancing one or more measures in the set of measures or both;
means for calculating a return on investment of the proposed project based on the modified set of measures and the additional threat.

20. The system of claim 18, wherein the current status is represented by a percentage value, with 100 percent representing full compliance with the one or more requirements and 0 percent indicating no compliance with the one or more requirements.

21. The system of claim 18, further comprising:
means for displaying the current status graphically, wherein the current status is indicated by one of the following colors: red, indicating no compliance or a low level of compliance; yellow, indicating a medium level of compliance; and green, indicating a high level of compliance or full compliance.

22. The system of claim 18, further comprising:
means for generating a report, the report indicating the level of compliance with the one or more requirements.
